(19) United States
(12) Patent Application Publication
(10) Pub. No.: US 2011/0135397 A1
(43) Pub. Date: Jun. 9, 2011

(54) EXTERNAL TURRET WITH ABOVE WATER CONNECTION POINT

(76) Inventor: Jacob de Baan, Maassluis (NL)

(21) Appl. No.: 12/901,044

(22) Filed: Oct. 8, 2010

(30) Foreign Application Priority Data
Oct. 9, 2009 (MY) PI 20094255

(51) Int. Cl. F16L 1/26; B63B 21/00

(52) U.S. Cl. 405/169; 114/230.15

(57) ABSTRACT

The present invention provides apparatuses for an offshore connection between a floating vessel and seabed pipelines.

### FIELD OF THE INVENTION

The present invention relates generally to apparatuses for an offshore connection between a floating vessel and seabed pipelines.

### BACKGROUND OF THE INVENTION

In offshore oil production, Floating Production Storage and Offloading (FPSO) ships or vessels are widely employed. These ships are moored at some suitable location in the field, generally by weathervaning mooring systems, such as for instance external turrets, well known in the industry. Also internal turrets and spread mooring solutions maybe applied subject to the environmental conditions and the water depth's at the mooring location. These turret systems are connected by one or more seabed pipe lines, partly flexible, partly rigid, to the point of origin of well fluids production. Such point of origin maybe a subsea wellhead at the seafloor or a wellhead platform structure carrying surface wellheads. The distance between such wellhead (platform) and the FPSO is generally between one to tens of kilometres.

The distance between the FPSO and these wellheads is spanned largely by rigid pipe lines (generally made of steel) on the seabed, while typically the last part near the FPSO is bridged with a flexible flow line, connected at their one end to the vessel mooring system and at their other end to the rigid pipelines on the seabed. Flexible flowlines, generically called risers, are generally a must in shallow water applications as the vessel moves continuously under the influence of waves, current and wind.

One character of weathervaning mooring systems is that the vessel can swing freely around the mooring system, while continuously flowing well streams to it onboard separation equipment.

Such systems are well known in the offshore industry. FIG. 1 shows a typical layout of the systems. The term mooring system is used here collectively for the complete assembly which incorporates anchor legs, anchor points, fluid swivel assemblies, rotating chain table and a defined manifold system to route well fluids and means to drive, launch and/or receive various pipeline cleaning devices.

From an operational perspective, there is the need to periodically clean the risers and the seabed pipelines from e.g. wax products that may have settled on the inner walls of these, as being exposed to the cold seawater. Such is usually done by passing so-called scraper pigs through the pipeline, whereby the wax is scraped off from the respective walls and pushed towards the cargo tanks of the FPSO.

At times, also the remaining wall thickness of the subsea pipelines needs to be verified to assure safe operation. For this, so-called intelligent pigs are employed.

Pigs that are used operationally in cleaning pipelines can be distinguished in so-called soft pigs, scraper pigs and intelligent pigs. Soft pigs are used to clean the flexible risers, scraper pigs are used to clean rigid seabed pipe lines and intelligent pigs are used to measure wall thickness of rigid pipelines.

Flexible risers, due to their inherent flexible and compositional characteristics, can only pass soft pigs, the other pig types would cause internal damage and ultimate jeopardise their integrity.

From this follows that the pigs used for the rigid seabed pipelines must always be inserted and extracted at the seabed. Only in exceptional cases where a water surface piercing wellhead platform is used they can be inserted above water. But for it to return to its starting point after a scraping operation, an expensive seabed pipeline of the same diameter is required. This is very costly if the Wellhead platform is located far away from the FPSO.

Often the seabed connection point between the risers and the seabed lines is configured such that a pig can be inserted or extracted by divers. This is cumbersome, expensive and not always environmentally clean, and a risk to personnel safety. Above water intervention for such operation would be a most desirable and efficient objective.

In FIG. 1, as prior art, a FPSO vessel 101 is moored in a body of water 102 and fitted with a mooring system 103, generally forward of the bow. The mooring system is fitted with a number of anchor legs 104 which are connected to the seabed 105 by anchors or piles 106. A flexible riser system 107 is arranged between the mooring system 103 and a pipeline end termination structure 108. The general shape of the riser system is maintained by partial buoyancy means 109. The riser end on structure 108 is connected to one end of the rigid seabed pipeline 110.

Particularly in shallow water, say less than 60 meters, and depending on the vessel size and wave height conditions in the field, it is very often difficult to configure a flexible riser layout 107 such as typically shown in FIG. 1, since the swing, circle of the keel of the vessel, near its maximum draft, rules out sufficient room for a flexible riser geometry that is-slack enough to follow all excursion motion of the vessel mooring system. This may easily lead to interference of the riser with the hull of the vessel, leads to chafing and results in damage to the flexible risers. In FIG. 1, the dotted line 111 indicates a possible orientation of the vessel 101 in a typical interference.

It is an objective of the present invention to provide apparatuses for an offshore connection between an external turret of a floating vessel with an above water connection point that will alleviate the above problems.

### SUMMARY OF THE INVENTION

The present invention provides apparatuses for an offshore connection between an external turret on a mooring system of a floating vessel with an above water connection point. The above water connection point comprises a pipeline manifold which in communication with seabed pipelines. A structure or frame construction is provided for supporting the above water connection point.

The structure is raised so that the connection point is located above the sea water level. The connection of a flexible riser from the turret mooring system with the connection point allows scraper pigs or intelligent pigs to be readily inserted or retracted from the rigid seabed pipelines by personnel under normal operating conditions, i.e. without the use of divers or such, and to provide means for cleaning the associated flexible risers without having to insert soft pigs or remove these at any other location than on board the FPSO mooring system itself. The structure also provide a vertical access to seabed connections.

The objective is achieved by following steps, of which the first two are essential and interdependent, the other steps being optional for any given application.
1) The connection point between flexible risers and rigid seabed pipelines is physically placed on top of a framed construction, extending some distance above a body of water, which is preferably rigidly connected to the seabed and located a suitable distance away from the centre of the mooring system on the FPSO. This suitable distance is determined by the need for the framed construction to clear the mooring system anchor lines and by the need to provide a certain minimum horizontal spacing between the turret chain table and the top of the framed construction such as to be able to accommodate freely suspended flexible risers of sufficient length to cater for all vessel movements and motions relative to the top of the stationary framed construction.

2) The FPSO is fitted with a mooring system of the external type, whereby the mooring system is located at the end of a long, above water, outrigger on the bow, the length of the outrigger being such that when the FPSO weathervanes, the vessel hull, above and below water portions, will at all times swing outside and above the obstruction formed by the framed construction standing on the seabed.

3) The FPSO mooring system is fitted with means to access the connection point from on-board the FPSO, when in any position or orientation relative to the framed construction.

4) The framed construction is fitted with pipeline intervention means as elucidated in FIG. 10

### BRIEF DESCRIPTION OF THE DRAWINGS

The present invention is described by way of example only, with reference to the accompanying drawings, in which:

FIG. 1 shows a side view of a typical connection between risers of a floating vessel with seabed pipelines;

FIG. 2 shows a side view of an example of connection between risers and elevated seabed pipelines according to an embodiment of the present invention;

FIG. 3 shows a top view of a typical sweep area of anchoring legs;

FIG. 4 shows a top view of a total sweep area of anchoring legs resulting from omni directional environmental conditions;

FIG. 5 shows a side view of an example of connection between risers and elevated seabed pipelines according to an embodiment of the present invention;

FIG. 6 shows a side view of an example of connection between risers and elevated seabed pipelines according to a preferred embodiment of the present invention;

FIG. 6a shows a side view of a top portion of apparatus shown in FIG. 6;

FIG. 7 shows a side view of an example of connection between risers- and elevated seabed pipelines according to another preferred embodiment of the present invention;

FIG. 8 shows a side view of the connection in benign wave;

FIG. 9 shows a side view of an example of connection between risers and elevated seabed pipelines according to yet another preferred embodiment of the present invention;

FIG. 10 shows an example of layout of the apparatus shown in FIG. 9.

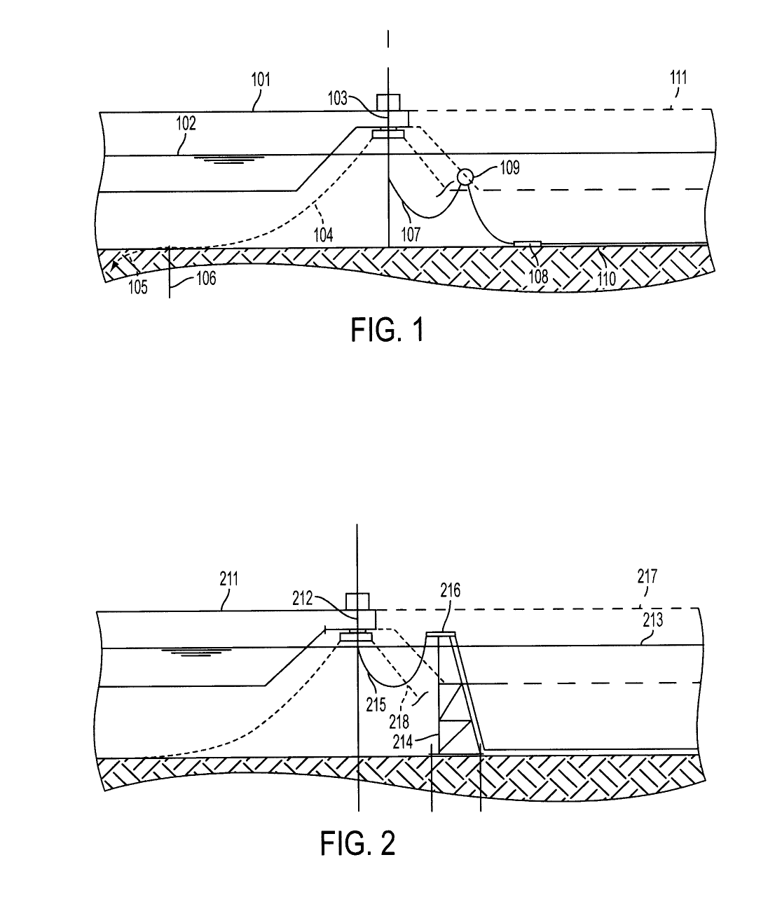

### DESCRIPTION OF EMBODIMENTS OF THE INVENTION

FIG. 2. shows an offshore connection between a FPSO vessel 211 and an above water connection point. The FPSO vessel 211 employing a typical external mooring system 212 is moored in a body of water 213. A framed construction 214 is rigidly fixed to the seabed at some distance away from the mooring system 212. Flexible risers 215 connect a mooring system chain table 212 with seabed pipelines ends 216 elevated above water level.

Dotted line 217 shows a possible orientation of the FPSO vessel 211 when the weather has changed direction in which the hull of the FPSO vessel 211 is likely to collide with the framed construction 214. This shows that the framed construction 214 cannot be placed closer to the mooring system 212 as anchor legs 218 would interfere the framed construction 214 as there is no sufficient distance between the mooring system 212 and the framed construction 218 to suspend one or more flexible risers .

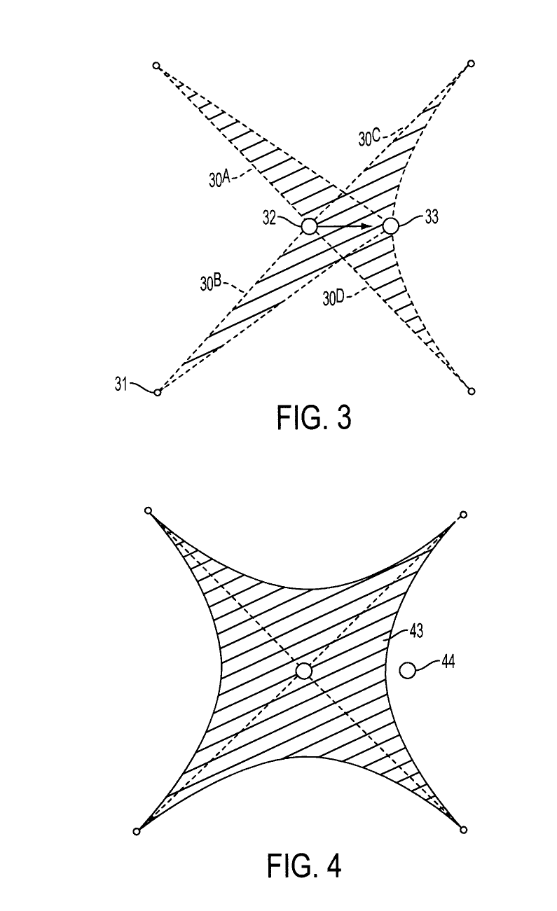

Therefore, the framed construction 214 must be placed at a distance away from the mooring system 212 at a distance specifically outside a sweep area of the anchoring legs . A typical sweep area is shown in FIG. 3.

FIG. 3 shows a top view of an anchoring system, anchor legs 30a, 30b, 30c, 30d and anchor points 31 and points 32 and 33 represent a neutral and a typical excursion of a mooring system. Since such excursion may take place 25. in any direction as a result of omni directional environmental conditions, a total anchor leg sweep area as marked by 43 in FIG. 4 is obtained. The preferred position, i.e. the closest possible position towards the centre of the mooring system for the framed construction is then found as marked 44. This position is dependant on the selection of the anchoring system parameters such as number of anchor legs, weight of the anchor legs and their pretension with the mooring system in a neutral, i.e. zero offset position. Typically, the framed construction can be safely positioned, free from anchor leg interference some 30-70% of the water depth away from the centre of the mooring system.

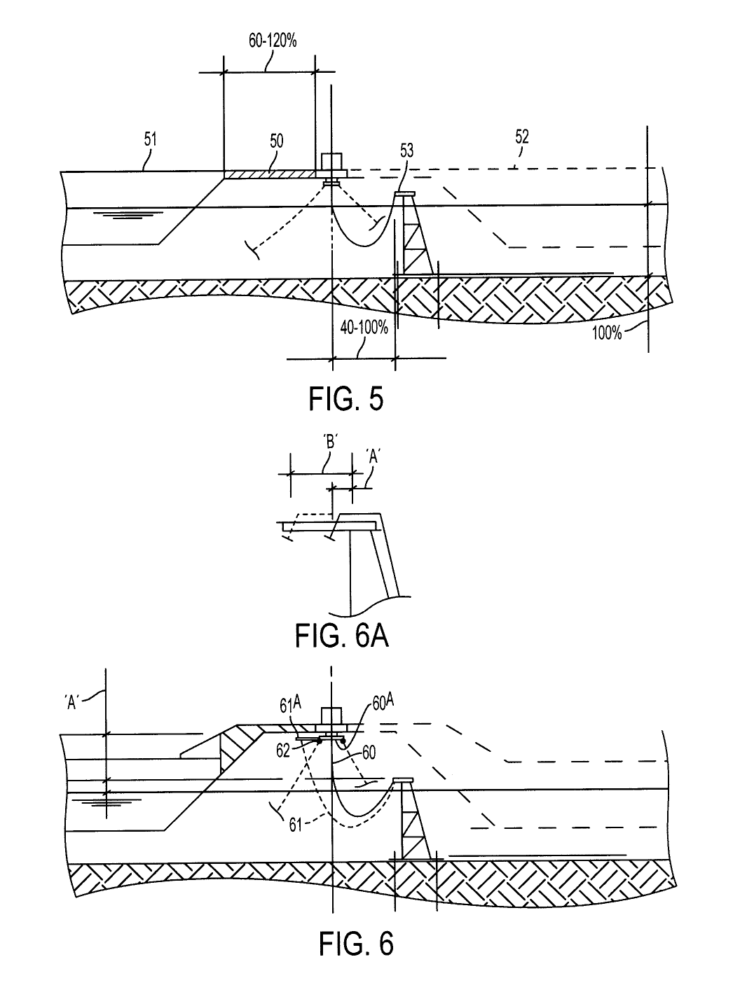

According to the present invention, in order to overcome the problem of interference due to the movement or orientation of the FSPO vessel shown by dotted line 217 in FIG. 2, an extended outrigger 50 shown in FIG. 5 is provided. The extended outrigger 50 will provide a sufficient distance to prevent collision between the hull of the FSPO vessel and the framed construction. In other words, the distance provided by the outrigger allows the vessel to revolve freely around the frame construction without being in contact with one another. FIG. 5 also indicates the possible relative dimensioning of the various distances and lengths as a percentage of the water depth, but all subject to the limitations described earlier.

Two possible orientations 51 and 52 of the vessel are shown In FIG. 5. The orientation of 52 indicates the worst interference that could happen in the field. As shown in FIG. 5, the extended distance of the outrigger 50 provides a clearance that prevents the collision between vessel and framed structure to happen.

In FIG. 5, the connection point between flexible riser and an elevated seabed pipeline is located above water level as indicated by 53. To accommodate the vertical vessel motions and in order to preserve a necessary clearance ‘A’ between the top of the framed construction and the underside of the extended outrigger, this outrigger is best configured elevated as shown in FIG. 6. The distance of the underside of the outrigger to the waterline is a function of the draft range of the vessel, the pitch response of the vessel bow to waves and of the desired height of the top of the framed construction above the waterline. FIG. 6 therefore represents the essential objective of the invention in its entirety.

It is obvious that many parameters can be varied to suit a specific application. There may be used three or more anchor legs. There may be used one or more framed constructions, there may be used one or more flexible risers.

A preferred embodiment of the present invention is illustrated in FIG. 6. In FIG. 6, a mooring .system having an external turret is provided. The external turret which is extended and raised to a location that distances the hull and outrigger of the vessel from said above water connection point to allow free movement of the vessel around said connection point. The mooring system comprises an alternate attachment point 60A for connecting a flexible riser 60. The attachment point 60A is usually located within the radius of the anchor leg attachments to a spider 62. An attachment point 61A in the form of hose is provided on a chain table of the mooring system, preferably located outside the radius of the anchor leg attachment. The attachment point is provided for connecting a larger diameter riser 61, which has a corresponding larger bending radius. The connection of the riser 61 to the connection point 61A is shown dotted by the dotted line.

FIG. 6A shows a top section of the above water connection point of FIG. 6 with the pipeline manifold located at the framed construction. The pipeline manifold is arranged so that can be arranged to a larger distance ‘B’ away from the front face of the framed construction than the apparently more logical position ‘A’. This automatically creates more free space for the riser(s) to move about in high waves without touching the framed construction. Obviously such could also be achieved by leaning the upper end of the framed construction over towards the turret, always satisfying that the above water part of the framed construction remains at a certain minimum distance from the anchoring system.

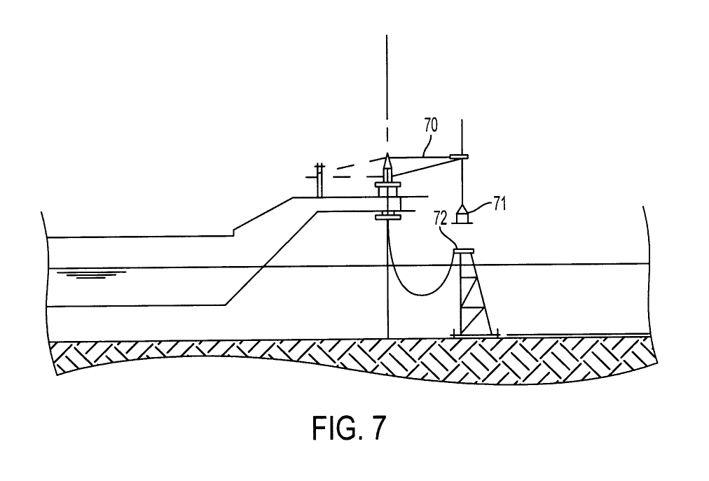

FIG. 7. shows a further practical application of the periodic transfer tools and personnel from the FPSO vessel directly to the top of the framed construction for intervention works such as insertion or removal of scraper or intelligent pigs, by a crane 70 and a platform 71 which can be landed and temporarily locked on the top 72 of the framed construction.

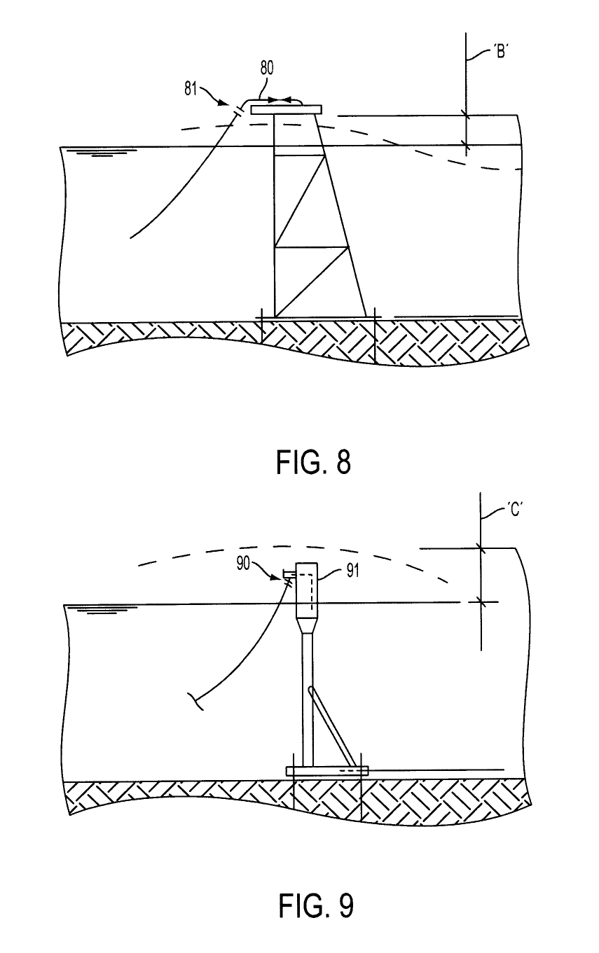

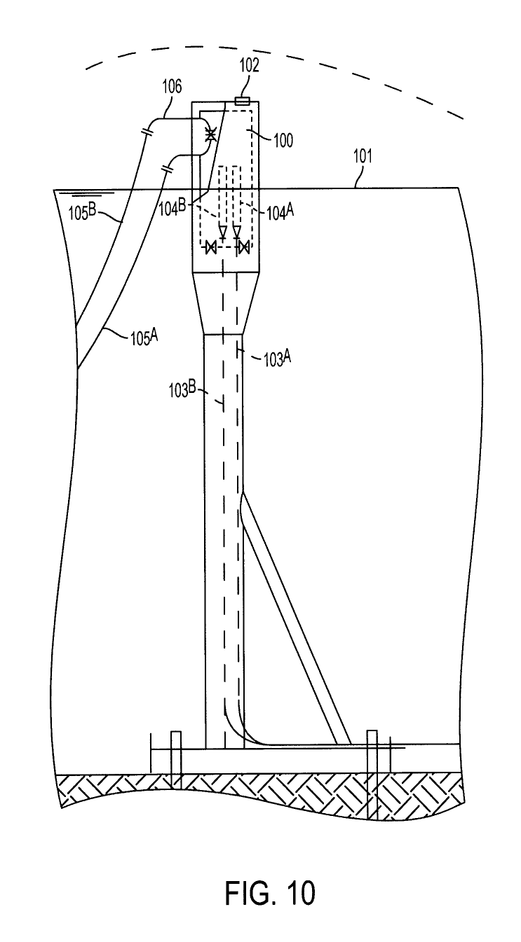

FIG. 8 shows a typical example of the framed construction when used in benign wave conditions. The connection point 80 between flexible risers and seabed pipelines, containing a number of valves and pig receivers if any, can be easily placed above the wave top elevation ‘B’ without suffering damage from wave impact.

FIG. 9 shows the framed construction as it is preferably executed in those offshore areas where wave crest elevations ‘C’ are large, e.g. more than say 5 meters on a regular basis. The connection point between flexible risers and the seabed pipelines 90, containing valves and pig receivers if any, are then preferably installed close to, and in,. an enclosed top 91 of the framed construction. This enclosed top is accessible in calm weather condition through a manhole. The enclosure then serves to protect valves and pig receivers from direct wave impact loads which could otherwise cause damage.

FIG, 10. shows a typical layout of the equipment located at the top of the framed construction. The top is configured as an enclosed space 100, well above still waterlines 101 (typically defined as either of Lowest Astronomical Tide, Highest Astronomical Tide or Mean Sea Level including Storm Surge) and accessible through a manhole 102. Inside the space 100 one or more seabed pipelines 103 terminate in pig launchers and/or receivers 104. Advantageously, one or more pairs of flexible risers 105A and 105 B are connected each to a pipe spool 106 which allow cleaning pigs to be run from the turret mooring system through riser 105A and return same through riser 105B. Valves, as required for the desired functionality of the piping system, may be automated and controlled directly from the turret mooring system.

1. An above water connection point between a floating vessel and seabed pipelines comprising
a pipeline manifold for receiving a riser connecting to the vessel;
a structure for supporting the pipeline manifold;
wherein the pipeline manifold is located on top of the structure and
raised above water level and in communication with seabed pipelines.

2. An above water connection point according to claim 1 wherein the structure is fixed on the seabed floor.

3. An above water connection point according to claim 1 wherein the pipeline manifold can be positioned at any required distance from the structure.

4. An above water connection point according to claim 1 wherein the pipeline manifold can be positioned at any required distance from the structure to allow a connected riser to move freely in high waves.

5. An above water connection point according to claim 1 wherein the pipeline manifold includes valves and pig receivers.

6. An above water connection point according to claim 1 wherein the top of the structure is for mounting a platform .

7. An above water connection point according to claim 1 wherein the platform can be temporarily locked on top of the structure.

8. An above water connection point according to claim 1 wherein the structure includes an enclosure for protecting the pipeline manifold and other related apparatus from waves.

9. A mooring system of a floating vessel to be connected to an above water connection point comprising
an external turret which is extended and raised to a location that distances the hull and outrigger of the vessel from said above water connection point to allow free movement of the vessel around said connection point.

10. A mooring system according to claim 9 wherein the external turret is extended and raised by extending and elevating the outrigger.

11. A mooring system according to claim 9 wherein the outrigger is mounted with a crane for hoisting a platform onto the above water connection point.

12. A mooring system of a floating vessel to be connected to an above water connection point comprising
an external turret which is extended and raised to a location that distances the hull and outrigger of the vessel from said above water connection point to allow free movement of the vessel around said connection point;
wherein said above water connection point comprises a pipeline manifold for receiving a riser connecting to the vessel and a structure for supporting the pipeline manifold; and said pipeline manifold is located on top of the structure and raised above water level and in communication with seabed pipelines.

13. An above water connection point according to claim 12 wherein the structure is fixed on the seabed floor.

14. An above water connection point according to claim 12 wherein the pipeline manifold can be positioned at any required distance from the structure.

15. An above water connection point according to claim 12 wherein the pipeline manifold can be positioned at any required distance from the structure to allow a connected riser to move freely in high waves.

16. An above water connection point according to claim 12 wherein the pipeline manifold includes valves and pig receivers.

17. An above water connection point according to claim 12 wherein the top of the structure is for mounting a platform .

18. An above water connection point according to claim 12 wherein the platform can be temporarily locked on top of the structure.

19. An above water connection point according to claim 12 wherein the structure includes an enclosure for protecting the pipeline manifold and other related apparatus from waves.

20. A mooring system according to claim 12 wherein the external turret is extended and raised by extending and elevating the outrigger.

21. A mooring system according to claim 12 wherein the outrigger is mounted with a crane for hoisting a platform onto the above water connection point.
